(19) United States
(12) Patent Application Publication
(10) Pub. No.: US 2026/0017218 A1
(43) Pub. Date: Jan. 15, 2026

(54) NETWORK-DRIVEN, INBOUND NETWORK DATA ORCHESTRATION

(71) Applicants: University of Kansas, Lawrence, KS (US); The Board of Trustees of the University of Illinois, Urbana, IL (US)

(72) Inventors: Mohammad Alian, Lawrence, KS (US); Nam Sung Kim, Urbana, IL (US); Siddharth Agarwal, Urbana, IL (US)

(21) Appl. No.: 19/113,316

(22) PCT Filed: Sep. 29, 2023
(86) PCT No.: PCT/US2023/075607

§ 371 Date: Mar. 19, 2025

Related U.S. Application Data
(60) Provisional application No. 63/412,223, filed on Sep. 30, 2022.

(51) Int. Cl. G06F 13/36; H04L 69/22

(52) U.S. Cl. CPC G06F 13/36; H04L 69/22; G06F 2213/40

(57) ABSTRACT

Aspects provide an intelligent direct input/output (IDIO) architecture for facilitating movement of data between processor cores and memories. A data packet is received at a network interface and classified based on its association with an application being processed by one or more cores of a processor. The disclosed IDIO architecture may determine to steer the data packet to a cache memory (e.g., a last level cache (LLC) or middle level cache (MLC)) or random access memory in response to receiving the data packet. The determination to steer the data packet to a particular memory may be based on characteristics of the data packet, the application, or other metrics. Where the data packet is steered to the MLC, the data packet may first be steered to the LLC and then prefetched to the MLC. The application may provide control information to invalidate a cacheline associated with the data packet one used.

### CROSS REFERENCE TO RELATED APPLICATIONS

The present application claims the benefit of priority from U.S. Provisional Patent Application No. 63/412,223, filed Sep. 30, 2022 and entitled “NETWORK-DRIVEN, INBOUND NETWORK DATA ORCHESTRATION,” the disclosure of which is incorporated by reference herein in its entirety.

### TECHNICAL FIELD

The present disclosure relates to management of data within a computing architecture and more specifically, to management of data within multi-level memory components and processing components of a computing system.

### BACKGROUND

High-bandwidth network interface cards (NICs), each capable of transferring 100s of Gigabits per second, are making inroads into the servers of next-generation datacenters. Such unprecedented data delivery rates impose immense pressure especially on the server's memory subsystem, as NICs transfer network data to dynamic random access memory (DRAM) first before processing. To alleviate the pressure, the cache hierarchy has evolved, supporting a direct data input/output (DDIO) technology to directly place network data in the last-level cache (LLC), sometimes referred to as an level 3 (L3) cache. Subsequently, various policies have been explored to manage the LLC and proven to be effective in reducing both service latency and memory bandwidth consumption of network applications. However, more recent evolution of the cache hierarchy decreased the size of LLC per core but significantly increased that of midlevel cache (MLC), also referred to as a level 2 (L2) cache, with a non-inclusive policy. While these changes have provided some improvements to the way in which data is handled within the memory (e.g., the L3/L2 caches) and processing cores, at least three shortcomings remain with current static data placement techniques for moving network data between the LLC, MLC, and processing cores. First, existing data placement techniques ineffectively use the MLC. The existing data placement techniques also suffer from high rates of writebacks from the MLC to the LLC. Finally, existing data placement techniques break the isolation between application and network data enforced by limiting cache ways for DDIO.

### BRIEF SUMMARY

Aspects provide an intelligent direct input/output (IDIO) architecture for facilitating movement of data between processor cores and memories. A data packet is received at a network interface and classified based on its association with an application being processed by one or more cores of a processor. The disclosed IDIO architecture may determine to steer the data packet to a cache memory (e.g., LLC or MLC) or random access memory (RAM) in response to receiving the data packet. The determination to steer the data packet to a particular memory may be based on characteristics of the data packet, the application, or other metrics. For example, where the application requires only access to a header of the packet, the payload of the packet may be steered to the RAM, while the header may be steered to the last-level cache (LLC), where it becomes available for use by the application. As another example, where the data packet is part of a burst of network traffic for the application, the data packet(s) may be steered to the midlevel cache (MLC). In such instances, the data packet(s) may be written to the LLC first and then prefetched to the MLC shortly afterwards, thereby increasing the speed at which the data packets may be utilized by the application(s). Furthermore, the applications may provide control information for invalidating a cacheline associated with the data packet once the data packet has been used. The IDIO architecture may reduce the number of writebacks that occur, resulting in more efficient operation of applications and the processors/memory on which the applications run despite high data traffic enabled by modern high-bandwidth network interface devices (e.g., network interface cards (NICs) operated at 100s of Gigabits per second).

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific aspect disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram of an exemplary system in which intelligent direct input/output (IDIO) techniques according to the present disclosure may be deployed;

FIG. 2 shows a block diagram of a computing architecture supporting IDIO techniques in accordance with the present disclosure;

FIG. 3 is a block diagram illustrating exemplary IDIO techniques in accordance with aspects of the present disclosure;

FIG. 4 is a flow diagram of a first method for providing IDIO processing in accordance with aspects of the present disclosure;

FIG. 5 is a flow diagram of a second method for providing IDIO processing in accordance with aspects of the present disclosure;

FIG. 6 is a state diagram illustrating features for providing IDIO processing in accordance with aspects of the present disclosure;

FIGS. 7A-7J show plots comparing MLC writeback and LLC writeback rates while processing one burst in TouchDrop for direct data input/output (DDIO) and IDIO at 100 Gbps and 25 Gbps burst rates;

FIG. 8 is a diagram comparing the number of midlevel cache (MLC) writebacks, last-level cache (LLC) writebacks, dynamic random access memory (DRAM) read, and DRAM write transactions during the burst shown in FIGS. 7A-7J;

FIGS. 9A-9D are diagrams illustrating processing of L2Fwd processes in accordance with aspects of the present disclosure;

FIG. 10 is diagram illustrating tail-latency mitigation and performance isolation using IDIO techniques in accordance with aspects of the present disclosure;

FIGS. 11A and 11B illustrate aspects of processing data in accordance with aspects of the present disclosure; and

FIG. 12 is a diagram that compares the statistics reported in FIG. 8 when sweeping mlcTHR value from 10 MTPS to 100 MTPS.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

To tackle the shortcomings of existing direct data input/output (DDIO) approaches and other techniques for managing the flow of data between dynamic random access memory (DRAM), the last-level cache (LLC), the midlevel cache (MLC), and the cores of a central processing unit (CPU), an intelligent direct I/O (IDIO) technology is disclosed herein that extends DDIO to MLC and provides three synergistic mechanisms: (1) a self-invalidating I/O buffer, (2) network-driven MLC prefetching, and (3) selective direct DRAM access. Exemplary aspects of the various features described above are explained in more detail below.

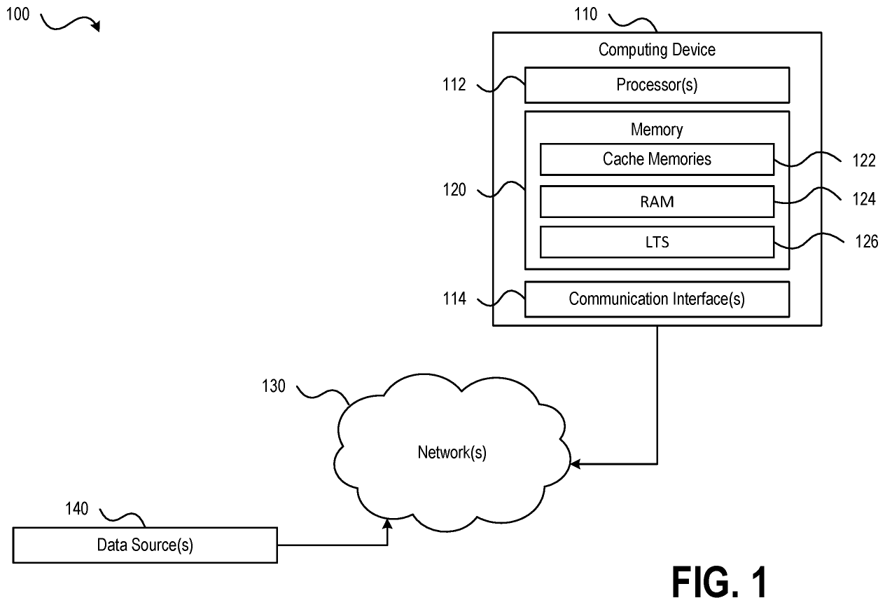

Referring to FIG. 1, a block diagram of an exemplary system in which IDIO techniques according to the present disclosure may be deployed is shown as a system 100. The system 100 includes a computing device 110 configured to receive data from a data source 140 over one or more networks 130. As shown in FIG. 1, the computing device 110 includes one or more processors 112, one or more communication interfaces 114, and a memory 120. The one or more processors 112 may include one or more central processing units (CPUs), graphics processing units (GPUs), or both, each having one or more processing cores. It is noted that while aspects of the present disclosure are predominately intended for use with CPUs and GPUs, computing devices implementing IDIO techniques in accordance with the present disclosure may include other types of computing/processing resources, such as digital signal processors (DSPs), application specific integrated circuits (ASICs), field programmable gate arrays (FPGAs), or other circuitry configured to process data in accordance with aspects of the present disclosure. The one or more communication interfaces 114 may include NICs or other devices (e.g., transceivers, receivers, transmitters, and the like) configured to communicatively couple the computing device 110 to the one or more networks 130 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like).

The memory 120 may include cache memories 122, random access memory (RAM) devices 124, and long term memory devices 126 (e.g., one or more hard disk drives (HDDs), one or more solid state drives (SSDs), flash memory devices, network accessible storage (NAS) devices, or other memory devices), or other types of memory configured to store data in a persistent or non-persistent state (e.g., read only memory (ROM) devices, erasable programmable ROM (EPROM), electrically erasable programmable ROM (EEPROM), etc.). Software configured to facilitate operations and functionality of the computing device 110 may be stored in the memory 120 as instructions that, when executed by the one or more processors 112, cause the one or more processors 112 to perform the operations described herein with respect to the computing device 110, as described in more detail below. As described above, the cache memories 122 may include MLCs, an LLC, or other forms of cache memory (e.g., an L1 cache).

As briefly described above, the present IDIO concepts disclosed herein are configured to enable efficient movement of data received at the one or more communication interfaces 114 to the memory 120 and the one or more processors 112. To illustrate, the one or more communication interfaces 114 may correspond to one or more high-bandwidth network interface cards (NICs), each capable of transferring 100s of Gigabits per second or greater from the data source(s) 140. As the packets of data are received at the NICs they may be provided to the memory 120 where they may be accessed by the one or more processors 112. More specifically, the packets may be provided to the LLC of the cache memories 122. To improve utilization of the MLCs of the cache memories 122, control information may be used to trigger an immediate prefetch (e.g., instead of a normal read operation) of the packets to an MLC associated with a processing core allocated to an application corresponding to the received packet data.

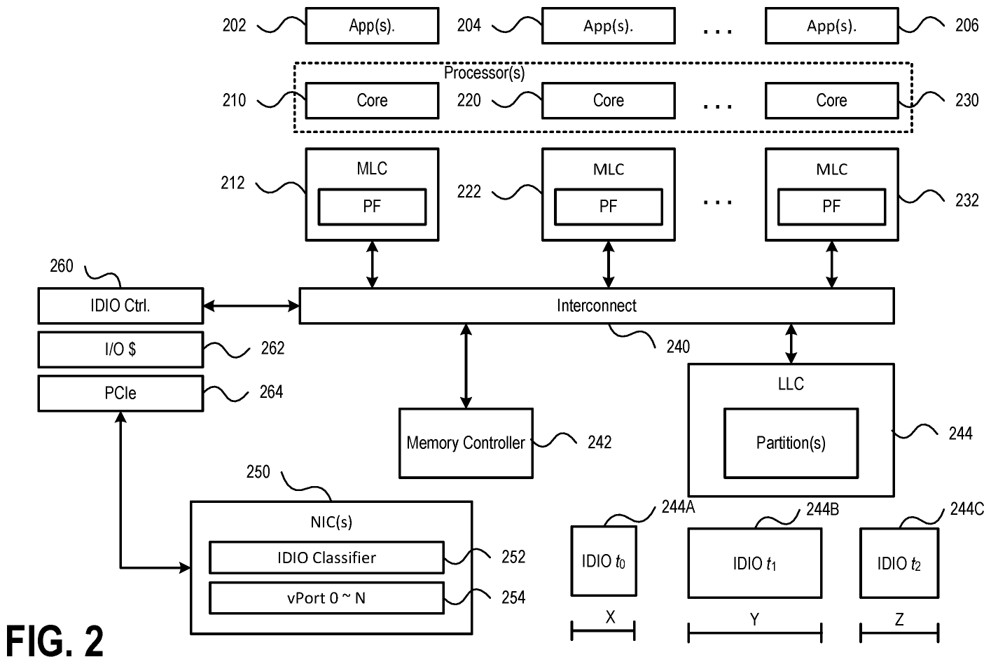

To illustrate and referring to FIG. 2, a block diagram of a computing architecture supporting IDIO techniques in accordance with the present disclosure is shown. As illustrated in FIG. 2, the computing architecture includes at least one processor (e.g., the processor(s) 112 of FIG. 1) having processor cores 210, 220, 230, MLCs 212, 222, 232, an LLC 244, a memory controller 242, an interconnect 240, at least one NIC 250 having an IDIO classifier 252 and a plurality of virtual ports (vPorts) 254, an IDIO controller 260, a PCIe interface 264, and I/O $ 262. Below, operations for performing IDIO operations using the computing architecture shown in FIG. 2 are described.

Unlike the DDIO techniques currently used, the computing architecture shown in FIG. 2 introduces two new components to support the IDIO techniques disclosed herein: the IDIO classifier 252 and the IDIO controller 260. The disclosed IDIO techniques also enhance the prefetcher (PF) of the MLCs 212, 222, 232 to support prefetches of received packet data stored in the LLC 244. For example, the IDIO controller 260 may provide control data configured to cause the prefetcher of a particular one of the MLCs 212, 222, 232 to prefetch data from the LLC 244 (e.g., as the data is stored in the LLC or shortly thereafter without receiving a read command). The disclosed IDIO techniques also provide functionality to extend cache maintenance instructions and implement a multi-cacheline invalidate instruction. The IDIO classifier 252 may reside in the NIC (e.g., the communication interface(s) 114) and implement logic to identify information associated with a destination for the packet data, such as application class, per-packet destination core, header versus payload, and start of an receive (RX) burst. The on-chip IDIO controller 260 collects the information embedded in each direct memory access (DMA) transaction from IDIO classifier 252 and monitors per-core MLC eviction statistics to determine the best placement for each traffic flow. Additional details regarding the operations of the IDIO classifier 252 and the IDIO controller 260 are described in more detail below.

As briefly explained above, the IDIO classifier 252 provides functionality to (1) identify the application class of each incoming packet, (2) identify the DMA transfer that contains the first byte of each RX packet, (3) identify the destination core for the RX packet, and (4) detect RX bursts destined for the same core. The IDIO classifier 252 may provide information regarding these characteristics to the IDIO controller 260. The IDIO controller 260 uses the classification information provided by the IDIO classifier 252 to intelligently steer RX packets within the memory hierarchy. To illustrate, assume that the sending application (e.g., an application associated with data source 140 of FIG. 1) includes information about the application class in the header of the packets it sends. For example, for transmission control protocol/internet protocol (TCP/IP) packets, applications can leverage the 8-bit differentiated services field (DS field) in the IP header for classification purposes. The 6-bit differentiated services code point (DSCP) field can be set by the setsockopt function for each socket connection and updated on the fly. DSCP can be used to distinguish packets coming from different applications with different DMA buffer use distances.

In a non-limiting example, two application classes may be defined: class 0 applications may be those with short use distance; and class 1 applications may be those with long use distance or applications that rarely use or process their payload. For instance, a Denial of Service (DOS) detention firewall application is a class 1 application (e.g., since inspection of headers is mostly sufficient for making a drop or pass decision and further inspection into the packet payload is rarely required). Such applications can benefit from direct DRAM access for payload to reduce LLC contention. As the header size of packets in all the well-known network protocols is less than 64 Bytes, the DMA transaction that transfers the very first cacheline of the RX packet contains the protocol header. The IDIO classifier 252 may mark the first DMA transactions carrying RX data to CPU as the cacheline that contains the header.

As IDIO supports network traffic steering to the MLCs, the destination core for each packet should be known to IDIO controller 260 to determine which MLC to steer the packet to, if MLC steering is deemed beneficial (e.g., based on an application as described above or another steering criterion). The IDIO classifier 252 builds on existing NIC support to determine each packet's destination core. For example, the IDIO classifier 252 may leverage single root input/output virtualization (SR-IOV) and Ethernet Flow Director to create several virtual NIC ports (vPort) and pin them to network sockets created on each core using Application Device Queue (ADQ). In general, the purpose of ADQ is to map RX/TX queues directly to the application so there are no DMA buffers or OS scheduler contention, such as may occur in a multi-programmed server. With ADQ, the application sets a hint (e.g., NAPI_ID), and uses this hint to map a socket to certain RX/TX queues (so those queues would go to this particular socket directly). Meanwhile, the NIC 250 is configured with rules (e.g., based on 5-tuple) so that the traffic can be directed to certain RX/TX queues (using Flow Director's perfect match Filter Table, as briefly described above), which in turn match particular sockets to corresponding applications. The IDIO classifier 252 also keeps a counter (e.g., a 32-bit burst counter) per physical core (i.e., cores 210, 220, 230) to keep track of received bytes for each core. The burst counters are reset every 1 ms. If the value of a counter exceeds a threshold (e.g., rxBurstTHR), the IDIO classifier 252 notifies the IDIO controller 260 of a burst arrival.

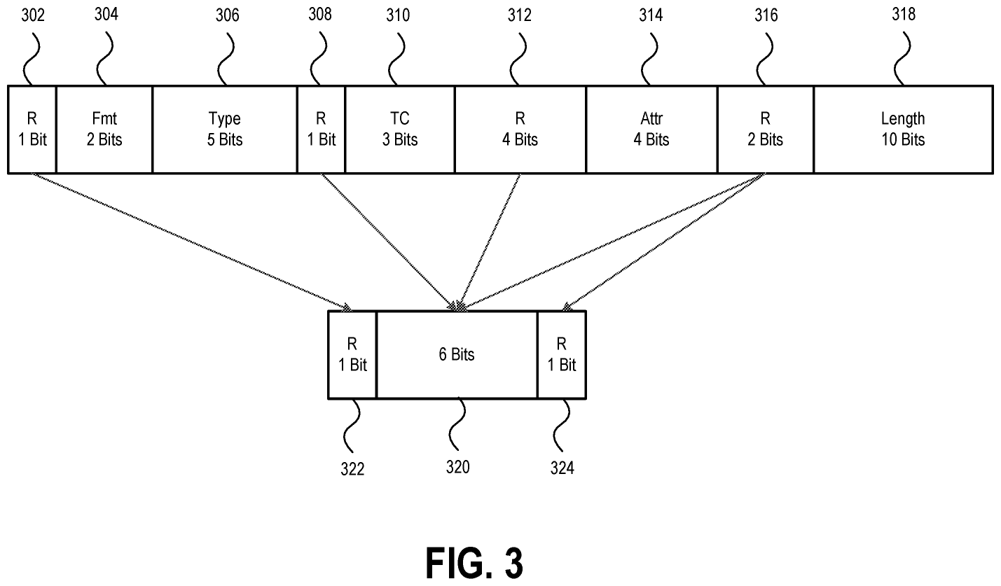

The metadata is extracted by the IDIO classifier 252 on the NIC to the on-chip IDIO controller 260 by embedding the metadata within each DMA request and leveraging the reserved bits inside the PCIe's Transaction Layer Packet (TLP) headers. The target core number is encoded in 6 bits of the PCIe TLP header's reserved bits. As a non-limiting example and referring to FIG. 3, an exemplary aspect for encoding a target core number into bits of a TLP header is shown. As illustrated in FIG. 3, the target core number 320 may be formed by bits 308, 312, 316. Bit 302 may be utilized to designate header payload (e.g., 0˜1) and 1 of bits 316 may be used to designate whether burst is being used (e.g., 0 for no burst and 1 for burst). The remaining bits 304, 306, 310, 314, 318 may be used to carry other information not used by IDIO. When an application class is 1, regardless of the core number, the IDIO technique disclosed herein may directly write the data to DRAM (e.g., RAM 124 of FIG. 1). Application class 1 may be identified by the IDIO controller 260 when these 6 bits 320 are set to 1. Using this encoding, IDIO supports up to 63 cores, and is therefore suitable to support the largest Xeon Scalable processor (Platinum 9282), which has 56 cores. However, it should be appreciated that additional techniques in accordance with the present disclosure may be used to support a higher number of cores as technology advances.

The IDIO controller 260 may be tightly coupled with the PCIe root complex (PCIe 264) on the CPU chip. The IDIO controller 260 makes steering decisions based on an algorithm (referred to herein as Algorithm 1 or Alg. 1), which may be expressed as:

```
Data Plane @ IDIO controller
DMA [appClass, isHeader, isBurst, destCore] write request is received
fsmState[destCore] = isBurst? 0:fsmState[destCore]
if isHeader then
    Send prefetch-hint to destCore
else if appClass == 1 then
    Direct DRAM write
else if status[destCore] == MLC then
    Send prefetch-hint to destCore
else
    Write-allocate or -update inside LLC
Control Plane @ IDIO controller
Every 1 ms:
  for i in (0, number of cores) do
    mlcPress = mlcWB[i] > (mlcWBAvg[i] + mlcTHR)? high:low
    update fsmState
    mlcWBAcc[i]+= mlcWB[i]
end
Every 8192 μs:
  for i in (0, number of cores) do
    mlcWbAvg[i] = mlcWbAcc[i] / 8192
    mlcWbAcc[i]= 0
end
```

As outlined in the exemplary algorithm above, the IDIO controller 260 uses per-packet information received from the IDIO classifier 252, and per-core MLC writeback statistics monitored within the CPU chip. The IDIO controller 260 maintains one counter, two registers, and one status register per physical core. The mlcWB counter counts MLC writebacks at 1 m intervals. The mlcWBAcc register accumulates 8192× consecutive samples of mlcWB. As shown, the mlcWBAvg stores the average number of MLC writebacks at 1 ms intervals over the past 8192 ms. It is noted that these intervals may be configurable and the exemplary values shown in the pseudocode above were chosen based on simulations run to test the IDIO techniques disclosed herein. Lastly, the status register indicates the destination of incoming DMA requests as follows: 0→LLC, 1→MLC.

If the DMA carries a header, regardless of its application class, it will be prefetched to MLC, as shown above. The rationale is that header size is small and the use distance of the header is usually short. If the application class (appClass) is 1, then DDIO is disabled for that transaction and the data is directly written into DRAM. If status bit of the destination core is 1 (i.e., the MLC of the destination core), the data will be prefetched to MLC. Otherwise, the DMA stays in the LLC 244.

The FSM implements a saturating counter to switch the status bit from MLC to LLC. That is, by default, the MLC prefetching for a physical core is disabled (state 0b11). Once a burst is identified for a physical core, the FSM transitions to state 0b00 (line 3 in Alg. 1). Every 1 ms, the IDIO controller 260 measures the MLC pressure by comparing the number of MLC writebacks during the past 1 ms interval (mlcWB) to the average writebacks over the past 8192 ms (mlcWBAvg). A difference of mlcWB and mlcWBAvg exceeding a threshold (mlcTHR) indicates high MLC pressure (mlcPress) and the saturating counter is incremented, otherwise it is decremented (saturating at 0b00 and 0b11). A state diagram illustrating the concepts described above is shown in FIG. 6. It is noted that while the exemplary algorithm described above and illustrated in FIG. 6 references specific parameters, such as measuring MLC pressure over 1 ms, such exemplary parameters should be understood as non-limiting examples and IDIO techniques operating in accordance with aspects of the present disclosure may utilize other parameters if desired to control the flow of data within an IDIO architecture.

The MLC controllers may implement a simple queued prefetcher logic that queue prefetch hints received from IDIO controller 260 for specific cache blocks and send prefetch requests to the LLC 244 accordingly. The IDIO architecture disclosed herein employs these prefetch hints to steer incoming network data to MLCs. The MLC prefetcher may utilize a default queue size, such as 32 requests. However, it is noted that this queue size may be configured to a higher or lower number of requests if desired.

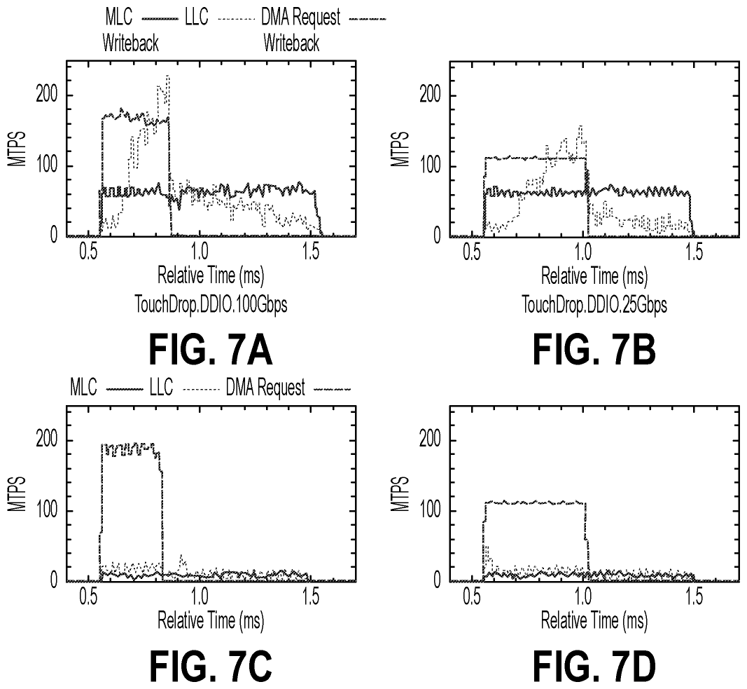

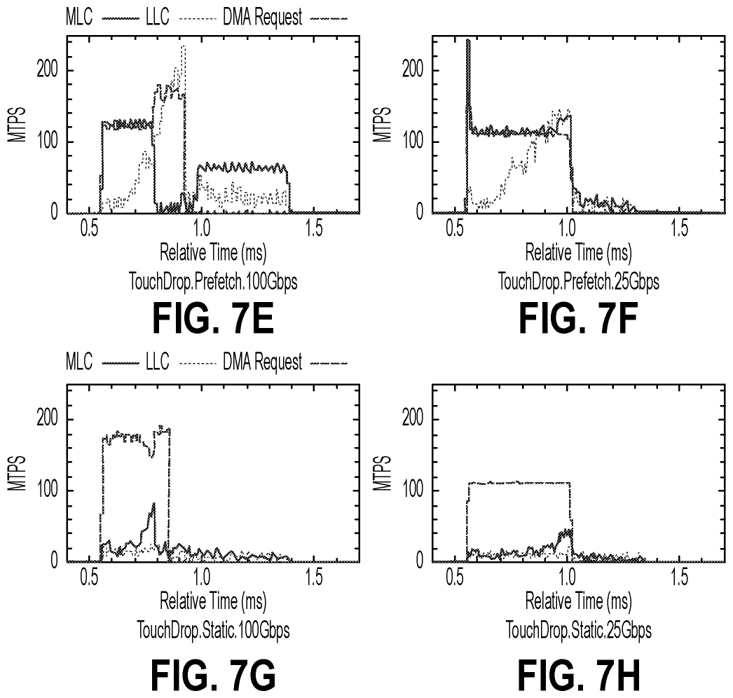

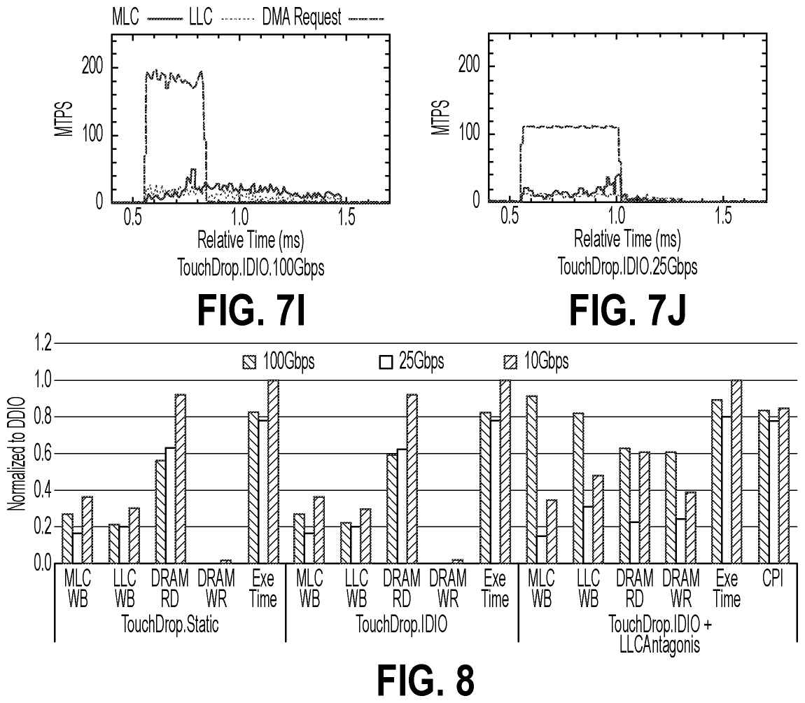

Modern ISAs support several cache maintenance instructions for cleaning and invalidating cachelines. For example, Data Cache Invalidate by Modified Virtual Address (DCIMVAC) operation in arm_v7 instruction set assembly (ISA) is used to invalidate a cacheline by virtual address, however, the cacheline will be written back if it is dirty before invalidation. In the disclosed IDIO architecture the cache invalidate operation is extended by introducing a new cache maintenance operation that invalidates a cacheline from private dcache and MLC, regardless of the dirty bit value. That is, the invalidation does not result in a writeback. The network application(s) (e.g., applications 202, 204, 206) may use the instruction to explicitly invalidate the DMA buffer after it is consumed by the software stack. Exemplary aspects of simulations performed using the above-described IDIO techniques to demonstrate the improvements provided by an IDIO architecture in accordance with the present disclosure, such as significantly reduced LLC writebacks at all load-levels and reduced processing time of a burst, are described in more detail below with reference to FIGS. 7A-12. Moreover, the IDIO architecture creates a synergy between self-invalidating and MLC prefetching techniques (e.g., self-invalidations significantly reduces both MLC and LLC writebacks while MLC prefetching reduces the burst execution time by increasing the aggregate residency of RX network data in the cache hierarchy).

The trend of increasing numbers of cores on the same chip and higher I/O device bandwidth demands fast and efficient on-chip communication. It is noted that prior attempts to improve on-chip have proposed a hardware assisted core-to-core queuing mechanism to reduce the coherence traffic and also enable fine-grained core-to-core communication. Additionally, a hardware coherence-assisted notification mechanism for multi-core software dataplane and extensions to the directory-based coherence protocols to offload the message synchronization and data copying to the hardware for accelerating MPI messages on a CMP have also been proposed, along with a line of work integrating the NIC to the CPU chip. It is to be appreciated that such techniques are orthogonal to and compatible with the IDIO architecture disclosed herein, with IDIO providing better I/O data movement than such other techniques alone.

Furthermore, data direct I/O (DDIO) technology injects I/O data directly to a CPU's LLC instead of detouring to DRAM, and several enhancements have been proposed for the default static DDIO. For example, IAT (as described in Y. Yuan et al., “Don't Forget the I/O When Allocating Your LLC,” 2021 ACM/IEEE 48th Annual International Symposium on Computer Architecture (ISCA), Valencia, Spain, 2021, pp. 112-125, doi: 10.1109/ISCA52012.2021.00018.) implements a dynamic DDIO policy by re-configuring DDIO LLC ways based on runtime monitoring of system stats to mitigate LLC writebacks. CacheDirector improves default DDIO to steer the header of each network packet into the LLC tile closest to the core that will process the packet, with the goal of reducing the processing latency for fine-grained network functions. However, due to the limited flexibility of the current commercial hardware, they are not able to fine tune the destination of the inbound data, and still suffer from the penalty of high MLC writeback rate. In contrast, the disclosed IDIO architecture proposes more comprehensive and fine-grained (both spatially and temporally) control mechanism for the inbound I/O traffic, which is especially important for the tail latency performance of the latency-critical network functions (NFs). DMA Cache identifies the different characteristics of DMA versus CPU data and introduce a cache structure specifically used for DMA data. The disclosed IDIO architecture may leverage such observations as well.

An additionally technique that may be utilized to support the IDIO techniques disclosed herein is dynamic partitioning of the LLC. For example, the LLC 244 may include various partitions, including a partition allocated for storage of data delivered to the LLC 244 using the IDIO techniques described above. As shown in FIG. 2, the partition allocated for supporting IDIO operations may have a default size, shown as IDIO partition 244A. To accommodate bursts of network packets during high volume traffic situations, a size of the IDIO partition 244 may be dynamically resized to increase the ability to store packet data in the IDIO partition 244A. For example, at a time t=1, the IDIO partition may be resized to increase the number of data packets that may be stored in the partition, as shown at 244B. As the traffic subsides, the size of the IDIO partition may be reduced, as shown at 244C. It is noted that increasing the size of the IDIO partition within the LLC may be performed incrementally (e.g., the size may be initially increased by a first amount and increased further as needed so long as the data packet traffic continues to remain high). Thus, it should be understood that IDIO architectures operating in accordance with the present disclosure may not only improve the ability to move data packets within a processing and memory architecture through intelligent analysis of target destinations for packet data and intelligent movement of data packets to RAM, the LLC, or the MLC according to the target destination for each packet, as described above, but may also leverage intelligent management of partitions within the LLC to accommodate sudden bursts of traffic that may result in large amounts of data being moved between the LLC, the MLC, and the processing cores.

As shown above, the disclosed IDIO architecture of the present disclosure provides new techniques for facilitating data movement in a non-inclusive cache hierarchy in the context of network applications. As can be appreciated from the description above, IDIO leverages three synergistic ideas for resolving the issues limiting current techniques for managing movement of data between cache memories and processing cores, such as self-invalidating I/O buffers, network-driven MLC prefetching, and selective direct DRAM access. As described in more detail below, the above-mentions simulations, which are described in more detail below, show that IDIO is very effective in reducing on-chip data movement and providing isolation for shared LLC when running various NFs.

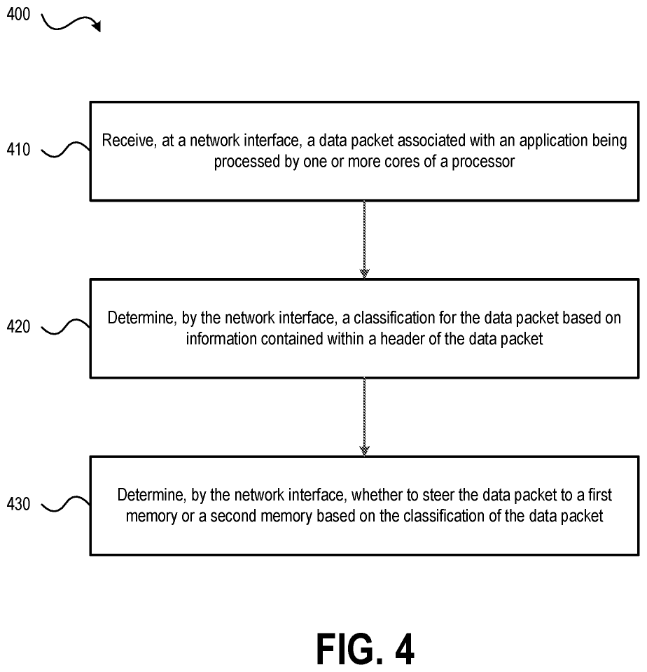

Referring to FIG. 4, a flow diagram of an exemplary method for processing data in accordance with aspects of the present disclosure is shown as a method 400. In an aspect, steps of the method 400 may be stored as instructions executable by one or more processors (e.g., the one or more processors 112 of FIG. 1) at a memory (e.g., the memory 120 of FIG. 1). Execution of the steps of the method 400 by the processor(s) may cause the one or more processors to perform operations for processing data in accordance with the concepts disclosed herein.

At step 410, the method 400 includes receiving, at a network interface, a data packet associated with an application being processed by one or more cores of a processor. As explained above, the data packet may be received at a network interface device, such as one of the communication interfaces 114 of FIG. 1 or the NIC(s) 250 of FIG. 2. As explained above, information associated with the data packet may include information that indicates one or more properties of the data packet, such as information associated with an application class, a core of the processor, and burst information (e.g., see FIG. 3). At step 420, the method 400 includes determining, by the network interface, a classification for the data packet based on information contained within a header of the data packet. In an aspect, the classification may be determined by an IDIO classifier (e.g., the IDIO classifier 252 of FIG. 2), as described above.

At step 430, the method 400 includes determining, by the network interface, whether to steer the data packet to a first memory or a second memory based on the classification of the data packet. The first memory may correspond to a cache memory of the processor and the second memory may correspond to a memory external to the processor, such as RAM or another form of memory external to the processor(s). In an aspect, the cache memory may include a last level cache (LLC). In an aspect, the method 400 may steer a payload of the data packet to the random access memory based on the classification of the data packet. Additionally or alternatively, the method 400 may steer a header of the data packet to the cache memory.

In an aspect, the method 400 may also include generating control information configured to initiate a prefetch of the data packet from the LLC to a MLC of the processor(s). As explained above, the prefetch may be performed immediately or almost immediately upon the data packet being stored in the MLC. In an aspect, the method 400 may include monitoring one or more metrics and initiating the prefetch of the data packet based on the one or more metrics. In an aspect, the method 400 may also include receiving invalidation information from the application and invalidating a cacheline corresponding to the data packet in response to receipt of the invalidation information, as explained above.

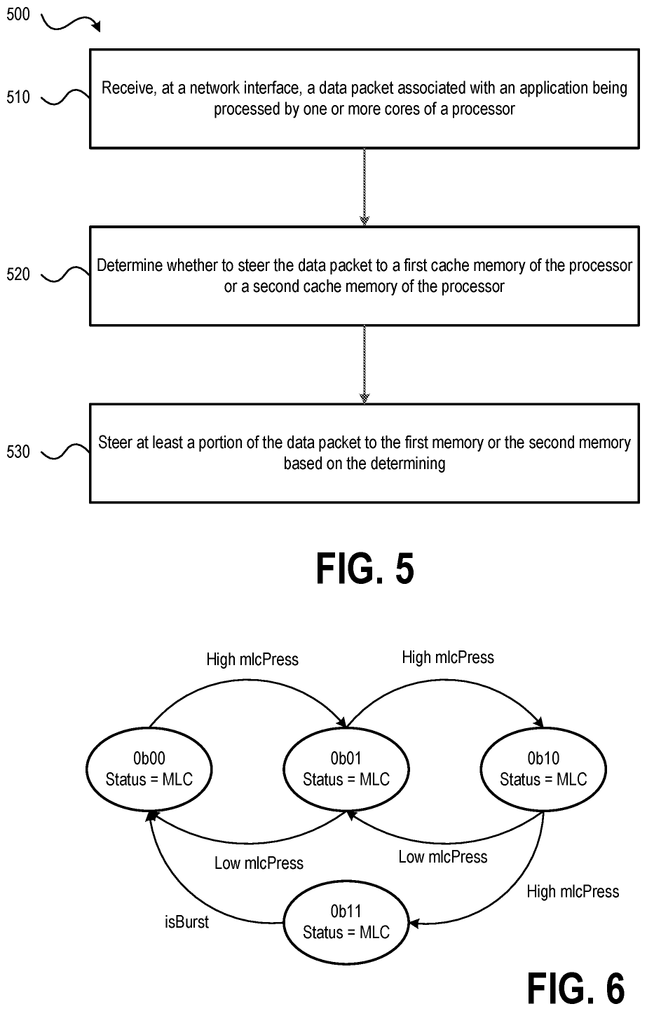

Referring to FIG. 5, a flow diagram of an exemplary method for processing data in accordance with aspects of the present disclosure is shown as a method 500. In an aspect, steps of the method 500 may be stored as instructions executable by one or more processors (e.g., the one or more processors 112 of FIG. 1) at a memory (e.g., the memory 120 of FIG. 1). Execution of the steps of the method 400 by the processor(s) may cause the one or more processors to perform operations for processing data in accordance with the concepts disclosed herein.

At step 510, the method 500 includes receiving, at a network interface, a data packet associated with an application being processed by one or more cores of a processor. At step 520, the method 500 may include determining, by the network interface, whether to steer the data packet to a first cache memory of the processor or a second cache memory of the processor. As explained above, information associated with the data packet may include information that indicates one or more properties of the data packet, such as information associated with an application class, a core of the processor, and burst information (e.g., see FIG. 3). The determination to steer the data packet to the first cache memory or the second cache memory may be determined based on the one or more properties of the data packet, such as based on whether the data packet is to be processed at a core of the processor associated with an application that needs the payload of the data packet or does not need to access or process the payload of the data packet (e.g., the application only needs to process a header of the data packet). In an aspect, the method 500 may include determining, by the network interface, a classification for the data packet, and the data packet may be steered to the first memory or the second memory based at least in part on the classification of the data packet, as explained above.

At step 530, the method 500 may include steering, by a controller, at least a portion of the data packet to the first cache memory or the second cache memory based on the determining. For example, as explained above a first portion of the data packet (e.g., a header of the data packet) may be steered to the second cache memory (e.g., the MLC) and a payload of the data packet may be steered to the second cache memory (or optionally a memory external to the one or more processors, such as RAM). In some aspects, the entire data packet may be routed to the first or second cache memory. As explained above, the portion of the data packet may be steered to the second memory by a prefetch operation subsequent to writing at least the portion of the data packet to the first memory.

It is noted that the exemplary operations of the methods 400 and 500 may utilize any of the techniques described herein to steer data packets received at a NIC and that different techniques for executing the steering may be applied to different data packets, such as to steer a first packet or portion thereof to the first memory (e.g., the MLC, the LLC, or RAM) and to steer a second packet or portion thereof to a different memory. Moreover, in some aspects, the methods 400 and/or 500 may determine whether it is beneficial to steer the data packet or portion thereof to a particular memory and may only steer the data packet to the particular memory when it is determined that it would be beneficial (e.g., reduce power consumption, provide an agreed upon level of service, and the like. Using the exemplary operations of the methods 400 and/or the method 500 may also result in faster data throughput (i.e., process more data in a given period time. Other advantages described herein may also be realized.

In an aspect, a first method is disclosed and includes receiving, at a network interface, a data packet associated with an application being processed by one or more cores of a processor. The first method may also include determining, by the network interface, a classification for the data packet based on information contained within a header of the data packet, and determining, by the network interface, whether to steer the data packet to a first memory or a second memory based on the classification of the data packet. The first memory corresponds to a cache memory of the processor and the second memory corresponds to a memory external to the processor. The cache memory may be a last level cache (LLC). The first method may include generating control information configured to initiate a prefetch of the data packet from the LLC to a middle layer cache (MLC) of the processor. The first method may include receiving invalidation information from the application and invalidating a cacheline corresponding to the data packet in response to receipt of the invalidation information. The first method may include monitoring one or more metrics and initiating the prefetch of the data packet based on the one or more metrics. The memory external to the processor may include a random access memory. The first method may include steering a payload of the data packet to the random access memory based on the classification of the data packet. The first method may include steering a header of the data packet to the cache memory. The first method may include other operations described above with reference to FIGS. 1-5.

In an additional aspect, a second method is disclosed and includes receiving, at a network interface, a data packet associated with an application being processed by one or more cores of a processor. The second method may include determining, by the network interface, whether to steer the data packet to a first cache memory of the processor or a second cache memory of the processor. The second method also includes steering, by a controller, at least a portion of the data packet to the first memory or the second memory based on the determining. The second method may include determining, by the network interface, a classification for the data packet. The data packet may be steered to the first memory or the second memory based at least in part on the classification of the data packet. The determining whether to steer the data packet to the first memory or the second memory may also include determining whether to steer at least a portion of the data packet to a third memory, the third memory corresponding to a memory external to the processor. At least the portion of the data packet may be steered to the first memory. At least the portion of the data packet may be steered to the second memory by a prefetch operation subsequent to writing at least the portion of the data packet to the first memory. The first method may include steering a payload of the data packet to the random access memory based on the classification of the data packet. The first method may include steering a header of the data packet to the cache memory. The first method may include other operations described above with reference to FIGS. 1-4 and 6.

In an additional aspect, a first system is disclosed and includes a first memory, a second memory, a processor, and a network interface. The network interface may be configured to: receive a data packet associated with an application being processed by one or more cores of the processor; determine a classification for the data packet based on information contained within a header of the data packet; and determine whether to steer the data packet to the first memory or the second memory based on the classification of the data packet. The first memory may correspond to a cache memory of the processor and the second memory may correspond to a memory external to the processor. The first memory may include a last level cache (LLC) of the processor. The network interface may be configured to generate control information configured to initiate a prefetch of the data packet from the LLC to a midlevel cache (MLC) of the processor. A cacheline of the MLC associated with the data packet may be invalidated in response to receiving the invalidation information from the application. The memory external to the processor may include a random access memory. The network interface may be configured to steer a payload of the data packet to the random access memory based on the classification of the data packet. The network interface may be configured to steer a header of the data packet to the cache memory. The first system may be configured to steer a payload of the data packet to the random access memory based on the classification of the data packet. The first system may be configured to steer a header of the data packet to the cache memory. The first system may include other operations described above with reference to FIGS. 1-5.

In an additional aspect, a second system is disclosed and includes a processor having a plurality of cores and a network interface. The network interface may be configured to: receive a data packet associated with an application being processed by one or more of the plurality of cores of the processor and determine whether to steer the data packet to a first memory or a second memory. The first memory may correspond to a first cache memory of the processor and the second memory may correspond to a second cache memory of the processor. The network interface may be configured to steer at least a portion of the data packet to the first memory or the second memory based on the determining. The second system may include other operations described above with reference to FIGS. 1-4 and 6.

Referring to FIGS. 7A-7J, plots comparing MLC writeback and LLC writeback rates while processing one burst in TouchDrop for DDIO and IDIO at 100 Gbps and 25 Gbps burst rates are shown. To show the synergy between the techniques, Invalidate (FIGS. 7C and 7D) and Prefetch (FIGS. 7E and 7F) configurations that only enable self-invalidating I/O buffers (described above) and network-driven MLC prefetching (described above) techniques were used. The Static configuration (FIGS. 7G and 7H) leaves MLC-prefetching always on and IDIO (FIGS. 71 and 7J) configurations enable both techniques. However, the static configuration always enables MLC prefetching for appClass: 0 (by hardcoding status register in Alg. 1 to MLC), but IDIO dynamically enables and disables MLC prefetching based on the FSM, as explained above with reference to FIG. 6. The DMA request rate of the TouchDrop application was also plotted (FIGS. 7A, 7B) to show different phases of the burst processing. Note that since TouchDrop only receives packets, all the DMA requests are write requests.

The execution phase starts approximately 1.9 us after the first DMA transaction. This delay is the time it takes for NIC to writeback the used descriptors to the CPU after the DMA-transfer of the RX data to the CPU is completed. Only after the descriptors are updated, the data plane development kit (DPDK) polling mode driver can detect packet arrival and start the execution phase (cf. FIGS. 7A-7J). The sampling interval for calculating the rates in FIGS. 7A-7J, 9A-9D, and 11A, 11B is 10 ms.

At the first glance, two things stand out in FIGS. 7A-7J: first is that IDIO significantly reduces the LLC writebacks at all load-levels, and second is that IDIO reduces the processing time of a burst. Moreover, FIGS. 7C and 7F clearly show the synergy between self-invalidating and MLC prefetching techniques. As evident in the figures, self-invalidations significantly reduce both MLC and LLC writebacks, while MLC prefetching reduces the burst execution time by increasing the aggregate residency of RX network data in the cache hierarchy.

FIG. 8 is a diagram comparing the number of MLC writebacks, LLC writebacks, DRAM read, and DRAM write transactions during the burst shown in FIGS. 7A-7J, normalized to that of DDIO. Exe Time in the figure is the burst processing time (i.e., start of DMA phase till end of execution phase) of IDIO normalized to the burst processing time of DDIO. The MLC writebacks at 100 Gbps, 25 Gbps and 10 Gbps are reduced by 73.9%, 83.7%, and 63.8% compared to DDIO, respectively. Likewise, IDIO significantly reduces LLC writebacks and DRAM bandwidth utilization. In fact, IDIO almost eliminates DRAM write bandwidth. Such data movement reductions in the memory subsystem results in 18.5% and 22.0% improvement in burst processing time at 100 Gbps and 25 Gbps, respectively.

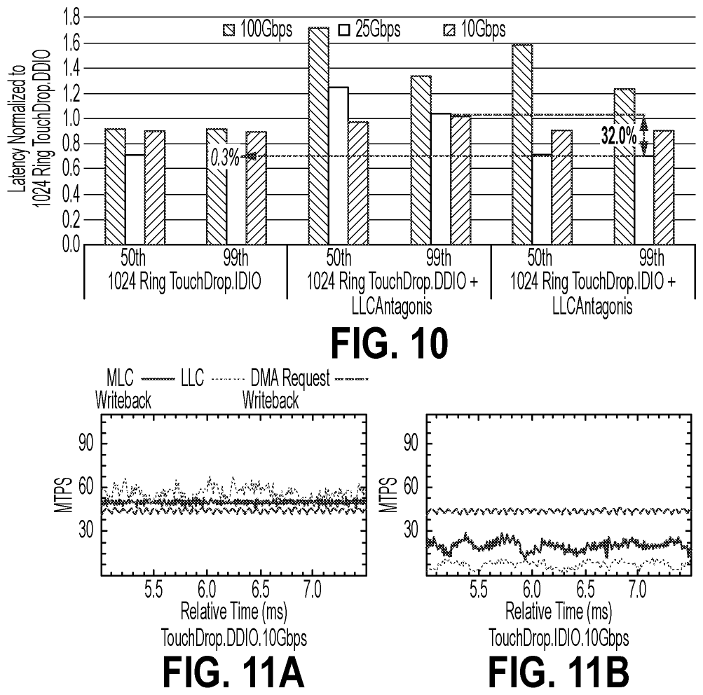

Although IDIO significantly reduces the number of MLC and LLC writeback transactions at all burst rates, FIG. 8 suggests that IDIO proves the most useful at 25 Gbps compared with 100 Gbps or 10 Gbps burst rates. The reason is that at high burst rates, the MLC-prefetching mechanism quickly fills up MLC and starts experiencing high MLC writebacks and gets disabled early on. However, at medium burst rates, while IDIO prefetches RX data to MLC, the core consumes data at a comparable rate and thus the self-invalidating mechanism in IDIO frees up MLC space for new prefetches. Such timely prefetch-invalidate is realized when IDIO prefetches at the same rate as the CPU consumes data. Although the simple queued prefetcher performs adequately well at all burst rates, a more sophisticated prefetcher that follows CPU pointer in the ring buffer to regulate the MLC prefetching rate is likely to be provide more benefit. Since at lower burst rates the CPU processes data as soon packets are arrived at the NIC, there is no room for IDIO to prefetch RX data into MLC. However, the self-invalidating mechanism is beneficial at any burst rate. Note that the reason that burst processing time is not improved in 10 Gbps rate is that packets are not queued up in the ring buffer and therefore improvement in per packet processing time does not improve the burst processing time. However, tail latency reduction even at 10 Gbps (as discussed later with reference to FIG. 10) is still seen.

The Static IDIO policy for MLC prefetching provides most of the benefits of the dynamic IDIO policy. The difference between Static and dynamic IDIO configurations in FIGS. 7G and 7I is where Static configuration lets MLC writeback rate exceed 50 MTPS but IDIO regulates MLC writeback rate by disabling MLC prefetching when MLC writeback rate exceeds mlcTHR (i.e., 50 MTPS). For lower burst rates like 25 Gbps, there is no difference between Static and IDIO since CPU consumption rate of DMA buffers is comparable to the DMA write rate and thus the self-invalidating mechanism frees up space in the MLC for new MLC prefetches without introducing MLC pressure. To summarize, the main takeaways from FIGS. 7A-7J are: (1) IDIO significantly reduces MLC and LLC writebacks, (2) IDIO improves packet processing rate, (3) IDIO's efficiency is not sensitive to the threshold values due to the seamless synergy between MLC prefetching and self-invalidating buffer at various burst rates.

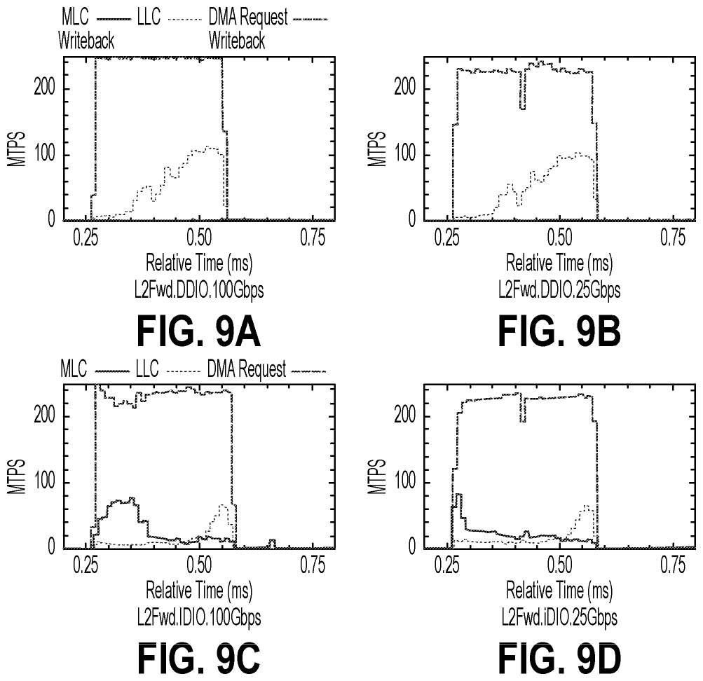

FIGS. 9A-9D show the MLC and LLC writeback rate timeline for L2Fwd with 1024 bytes packets with DDIO and IDIO configurations. L2Fwd implements a zero-copy run-to-completion buffer recycling model and uses the RX DMA buffer for forwarding the packet back to the network. Therefore, a DMA buffer is consumed only after the forwarding is completed. In the baseline DDIO, the payload remains in the LLC or leaks to DRAM and only the header is used in L2Fwd for processing. Since the header size is small (even a full 1024 size ring buffer only takes 64 KB), as shown in FIGS. 9A and 9B, there is almost no MLC activity in DDIO configuration. However, LLC writeback rate gradually increases as more data is received from the network. These writebacks can be DMA leaks (not consumed DMA buffers) or unnecessary writeback of consumed DMA buffers. In contrast, IDIO significantly reduce the LLC writebacks by: (1) effectively utilizing the unused MLC space to admit data to the non-inclusive MLC and reduce the LLC contention, and (2) invalidating consumed LLC-resident buffers after the forwarding is completed. IDIO explores an interesting data steering option of data admission to higher level memory versus data eviction to lower-level memory. Such data steering has not been an option in inclusive cache hierarchies and needs to be further explored at non-inclusive cache hierarchies.

IDIO also supports direct DRAM access for application classes that have high use distance of the RX payloads. L2Fwd does not fit into this class as the payload is quickly used for transmission. The direct DRAM access feature of IDIO was evaluated by running a variant of L2Fwd where the application drops the payload after processing the header. As explained above, each packet may carry the class information of the sending application and in the RX server IDIO directly transfers the payload to DRAM. In this scenario, the LLC writeback rate and DRAM write bandwidth are the same as network RX bandwidth.

To quantify the benefit of less LLC interference, LLCAntagonist and Touch-Drop were co-run with 1024 ring buffer size and 1514 byte packets at various burst rates. As illustrated in FIG. 8 (TouchDrop.IDIO+LLCAntagonist configuration), IDIO is effective in reducing MLC and LLC writebacks and DRAM bandwidth utilization even when co-running an NF with an LLC intensive application. More importantly, co-running with IDIO improves burst processing time by 10.9% and 20.8% for 100 Gbps and 25 Gbps compared with baseline DDIO, respectively.

The common programming interface (CPI) of the LLCAntagonist is also improved by 16.8%, 22.1%, and 15.7% respectively. Tail-latency mitigation and performance isolation is shown in FIG. 10, which is a diagram that compares the 50th and 99th percentile latency of packets processed in TouchDrop using 1024 ring buffer sizes when running solo and co-run with LLCAntagonist. All data points were normalized to DDIO's solo run. IDIO reduces TouchDrop's 99th latency by 7.9%, 30.5%, and 10.9% when running solo, and 6.1%, 32.0%, and 8.2% when co-running at 100 Gbp, 25 Gbps, and 10 Gbps, respectively. As shown, IDIO also provides isolation between the network function and LLCAntagonist at 25 and 10 Gbps rates. At higher network rates, the network function becomes too sensitive to LLC interference and a more sophisticated mechanism is required to provide performance isolation effectiveness of IDIO in reducing MLC and LLC writebacks where each TouchDrop receives steady network traffic at 10 Gbps rate (total 20 Gbps). Note that packet drops were experienced at network rates higher than 12 Gbps for each core. Although the LLC writeback rate is not as significant as when a burst is received, FIG. 11A shows that DDIO experiences consistent MLC and LLC writebacks at a steady RX rate. In fact, the MLC writeback rate is the same as bursty traffic. The reason is that most of the MLC writebacks belong to the consumed DMA buffers, and since packet processing rate on the CPU is the same as when a burst of packet is received, DDIO experiences the same MLC writeback rate in both steady and bursty traffic. The self-invalidating DMA buffer mechanism provided by IDIO removes most of the MLC writebacks and significantly reduces LLC writebacks.

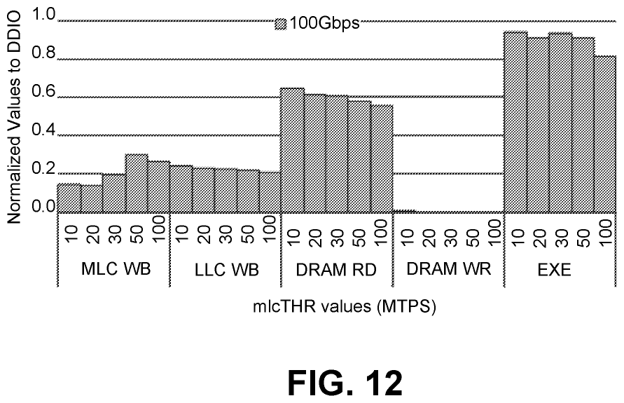

Lastly, it has been demonstrated that IDIO is not overly sensitive to the value of mlcTHR threshold. For example, FIG. 12 is a diagram that compares the statistics reported in FIG. 8 when sweeping mlcTHR value from 10 MTPS to 100 MTPS. Note that mlcTHR was set to 50 MTPS for all the previously reported results. As illustrated in FIG. 12, IDIO consistently improves the reported statistics regardless of the threshold value. We only show the sensitivity analysis for 100 Gbps burst rate because as the burst rate decreases, the sensitivity to the mlcTHR also decreases. As can be appreciated from the performance metrics illustrated in FIGS. 7A-12, it is to be appreciated that the IDIO techniques described herein provide superior performance across a variety of measurable performance indicators and more efficiently handles processing of received data in high data rate environments. It should be appreciated that while exemplary configurations and data rates have been described with reference to FIGS. 7A-12, the concepts described herein for providing data processing using IDIO may be utilized with other parameters and configurations if desired.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding aspects described herein may be utilized according to the present invention. Accordingly, the appended claims are intended to include within their scope such processes, machines, manufacture, compositions of matter, means, methods, or steps.

Moreover, the scope of the present application is not intended to be limited to the particular aspects of the process, machine, manufacture, composition of matter, means, methods and steps described in the specification.

What is claimed is:

1. A method comprising:
receiving, at a network interface, a data packet associated with an application being processed by one or more cores of a processor;
determining, by the network interface, a classification for the data packet based on information contained within a header of the data packet; and
determining, by the network interface, whether to steer the data packet to a first memory or a second memory based on the classification of the data packet, the first memory corresponding to a cache memory of the processor and the second memory corresponding to a memory external to the processor.

2. The method of claim 1, wherein the cache memory comprises a last level cache (LLC).

3. The method of claim 2, further comprising generating control information configured to initiate a prefetch of the data packet from the LLC to a middle layer cache (MLC) of the processor.

4. The method of claim 3, further comprising:
receiving invalidation information from the application; and
invalidating a cacheline corresponding to the data packet in response to receipt of the invalidation information.

5. The method of claim 3, further comprising:
monitoring one or more metrics; and
initiating the prefetch of the data packet based on the one or more metrics.

6. The method of claim 1, wherein the memory external to the processor comprises a random access memory.

7. The method of claim 6, further comprising steering a payload of the data packet to the random access memory based on the classification of the data packet.

8. The method of claim 7, further comprising steering a header of the data packet to the cache memory.

9. A method comprising:
receiving, at a network interface, a data packet associated with an application being processed by one or more cores of a processor;
determining, by the network interface, whether to steer the data packet to a first cache memory of the processor or a second cache memory of the processor; and
steering, by a controller, at least a portion of the data packet to the first memory or the second memory based on the determining.

10. The method of claim 9, further comprising determining, by the network interface, a classification for the data packet, wherein the data packet is steered to the first memory or the second memory based at least in part on the classification of the data packet.

11. The method of claim 9, wherein the determining whether to steer the data packet to the first memory or the second memory further comprises determining whether to steer at least a portion of the data packet to a third memory, the third memory corresponding to a memory external to the processor.

12. The method of claim 9, wherein at least the portion of the data packet is steered to the first memory.

13. The method of claim 12, wherein at least the portion of the data packet is steered to the second memory by a prefetch operation subsequent to writing at least the portion of the data packet to the first memory.

14. A system comprising:
a first memory;
a second memory;
a processor; and
a network interface configured to:
receive a data packet associated with an application being processed by one or more cores of the processor;
determine a classification for the data packet based on information contained within a header of the data packet; and
determine whether to steer the data packet to the first memory or the second memory based on the classification of the data packet, the first memory corresponding to a cache memory of the processor and the second memory corresponding to a memory external to the processor.

15. The system of claim 14, wherein the first memory comprises a last level cache (LLC) of the processor, and wherein the network interface is configured to generate control information configured to initiate a prefetch of the data packet from the LLC to a middle layer cache (MLC) of the processor.

16. The system of claim 15, wherein a cacheline of the MLC associated with the data packet is invalidated in response to receiving the invalidation information from the application.

17. The system of claim 14, wherein the memory external to the processor comprises a random access memory.

18. The system of claim 17, wherein the network interface is configured to steer a payload of the data packet to the random access memory based on the classification of the data packet.

19. The system of claim 17, wherein the network interface is configured to steer a header of the data packet to the cache memory.

20. A system comprising:
a processor having a plurality of cores; and
a network interface configured to:
receive a data packet associated with an application being processed by one or more of the plurality of cores of the processor;
determine whether to steer the data packet to a first memory or a second memory, the first memory corresponding to a first cache memory of the processor and the second memory corresponding to a second cache memory of the processor; and
steer at least a portion of the data packet to the first memory or the second memory based on the determining.
